(19) United States
(12) Patent Application Publication
(10) Pub. No.: US 2010/0309121 A1
(43) Pub. Date: Dec. 9, 2010

(54) ELECTONIC APPARATUS WITH DEVIATION CORRECTION OF CURSOR POSITION

(76) Inventors: Kai-Fen Huang, Banqiao City (TW); Jr-Wei Lian, Banqiao City (TW)

Correspondence Address: SINORICA, LLC, 2275 Research Blvd., Suite 500, ROCKVILLE, MD, 20850, US

(21) Appl. No.: 12/722,630

(22) Filed: Mar. 12, 2010

Related U.S. Application Data
(63) Continuation-in-part of application No. 12/712,955, filed on Feb. 25, 2010.

(30) Foreign Application Priority Data
Jun. 9, 2009 (TW) 098119139
Aug. 28, 2009 (TW) 098215869

(51) Int. Cl. G09G 5/08

(52) U.S. Cl. 345/157

(57) ABSTRACT

An electronic apparatus with deviation correction of cursor position is disclosed. The electronic apparatus with deviation correction of cursor position is configured between a wireless pointing device and a host for controlling the screen cursor by means of receiving a movement data from an inertial sensor and a display data from a display controlled by the host so as to calculate a distance deviation value of the cursor position with respect to the screen coordination, thereby effectively controlling the cursor movement.

### CROSS-REFERENCE TO RELATED APPLICATIONS

The current application is a Continuation-in-part of U.S. Application Ser. No. 12/712,955 entitled “METHOD OF CALIBRATING POSITION OFFSET OF CURSOR” filed on Feb. 25, 2010, which claimed a foreign priority to a patent application in Taiwan with serial number TW098119139, filed on 6-9-2009.

The current application claims priorities to the following U.S. patent application and two foreign patent applications.
1. U.S. Ser. No. 12/712,955, filed on 2-25-2010
2. Taiwan 098215869, filed on 8-28-2009
3. Taiwan 098119139, filed on 6-9-2009

### BACKGROUND OF THE INVENTION

1. Technical Field

The invention relates to an electronic apparatus with offset correction for controlling cursor movement, and more particularly to an electronic apparatus for controlling cursor movement based on the offset correction between a wireless pointing device and a host with a monitor to display the cursor movement.

2. Description of Related Art

Owing to higher price of inertial sensor products, the inertial sensor products are few in the early market. However, the price of inertial sensor products will decrease to an acceptable level for consumers as the evolution and integration of MEMS and CMOS process can be performed. Therefore it is a trend in future to utilize inertial sensor, such as accelerometer and gyroscope etc, in consumer products to detect a movement of a user. Under the trend, inertial sensors are widely accepted in cursor devices for the personal computer, pointing devices for presentation, and remote device for home appliances so as to provide users with friendly control interface.

However, the design style of the inertial sensor products in market nowadays is extended merely from a cursor control by a remote pointing device. Therefore, a problem dealt with controlling cursor movement is arisen in a case where such a situation that how the remote pointing devices can be friendly used by the users. When the pointing device has already been moved to a position beyond the screen boundary, the cursor on the screen will stay at the boundary of the boundary so as to result in a shifting (or offset) displacement or an angle offset of the point devices in reference to the cursor position. If the cursor is moved towards the opposite direction of the screen boundary, the cursor will instantly start to move. As time passes, a position offset between the pointing device and the cursor position will be increased with errors and thus the errors are accumulated, thereby bringing inconvenience to a user who has to press the calibration or reset key so frequently for controlling the cursor movement in a user-unfriendly way.

### SUMMARY OF THE INVENTION

To solve the problems and the drawbacks encountered in the prior art, the present invention discloses an electronic apparatus with offset correction for controlling cursor movement so as to reduce a cursor position offset between a wireless pointing device and a monitor in a first embodiment of the present invention. The electronic apparatus comprises a wireless pointing device, an offset calibration unit and a host. The wireless pointing device comprises a first wireless transceiver module, a microcontroller module and an inertial sensor module. The inertial sensor is adapted to detect a movement of the wireless pointing device so as to output a moving displacement corresponding to the movement of the wireless pointing device. The microcontroller module is adapted to output a displacement data corresponding to the moving displacement. The first wireless transceiver module is adapted to transmit the displacement data via a wireless transmission mode. The host comprises a third USB transceiver module, an image processing module and a monitor. The monitor is adapted to display a cursor for users. The image processing is adapted to process a position data of the cursor and a resolution data of the monitor. The third USB transceiver module is adapted to operate data communication with the offset calibration unit. The offset calibration unit comprises a second wireless transceiver module, a second USB transceiver module, an offset correcting calculation module and a memory storage module. The second wireless transceiver module is adapted to receive the displacement data from the wireless pointing device via the wireless transmission mode. The second USB transceiver module is adapted to operate data communication with the host. The offset correcting calculation module is adapted to receive the displacement data from the second wireless transceiver and the resolution data from the second USB transceiver module so as to control the movement of the cursor for further controlling cursor movement on the monitor. The memory storage module is adapted to store all the required data pertaining to calculation of the offset value generated from the offset correcting calculation module.

In addition, the present invention provides an electronic apparatus with offset correction for controlling cursor movement to solve the offset problem arisen from a wireless pointing device and a cursor on a monitor in a second embodiment of the present invention. The electronic apparatus comprises a wireless pointing device, an intermediary means, and a host. The wireless pointing device comprises a first wireless transceiver module, a microcontroller module and an inertial sensor module. The inertial sensor module is adapted to detect a movement of the wireless pointing device so as to output a moving displacement corresponding to the movement of the wireless pointing device. The microcontroller module is adapted to output a displacement data corresponding to the moving displacement. The first wireless transceiver module is adapted to transmit the displacement data via a wireless transmission mode. The intermediary means is configured between the wireless pointing device and the host, and comprises a second wireless transceiver module and a second USB transceiver module. The second wireless transceiver module is adapted to receive the displacement data from the wireless pointing device via the wireless transmission mode. The second USB transceiver module is adapted to receive and transmit the displacement data. The host comprises a third USB transceiver module, an image processing module, and a monitor. The monitor is adapted to display a cursor. The third USB transceiver module is adapted to receive the displacement data from the intermediary means. The image processing module is adapted to process a position data of the cursor and a resolution data of the monitor. The host further comprises an offset correcting calculation module and a memory storage module. The offset correcting calculation module is adapted to receive the displacement data from the third USB transceiver module and the resolution data from the image processing module so as to calculate an offset value pertaining to the position data of the cursor for further controlling cursor movement on the monitor. The memory storage module is adapted to store all the required data pertaining to calculation of said offset value in the offset correcting calculation module.

In addition, the present invention provides an electronic apparatus with offset correction for controlling cursor movement to solve the offset problem arisen from a wireless pointing device and a cursor displayed on a monitor in a third embodiment of the present invention. The electronic apparatus comprises a host and a wireless pointing device. The host comprises a third wireless transceiver module, an image processing module and a monitor. The monitor is adapted to display a cursor. The image processing module is adapted to process a position data of the cursor and resolution data of the monitor. The third wireless transceiver module is adapted to operate data communication with the wireless pointing device via a wireless transmission mode. The wireless pointing device comprises an inertial sensor module and a first wireless transceiver module. The inertial sensor module is adapted to detect a movement of the wireless pointing device so as to output a displacement data. The first wireless transceiver module is adapted to operate data communication with the host via the wireless transmission mode. The wireless pointing device further comprises an offset correcting calculation module and a memory storage module. The offset correcting calculation module is adapted to receive the resolution data from the host through the first wireless transceiver module and the displacement data from the inertial sensor module for calculating an offset value pertaining to the position data of the cursor and subsequently transmitting the offset value to the host through the first wireless transceiver module so as to allow the image processing module to control cursor movement of the monitor. The memory storage module is adapted to store all the required data pertaining to calculation of the offset value generated form the offset correcting calculation module.

In addition, the present invention further provides an electronic apparatus with offset correction for controlling cursor movement to solve the offset problem arisen from a wireless pointing device and a cursor on a monitor in a fourth embodiment of the present invention. The electronic apparatus with offset correction for controlling cursor movement comprises a wireless pointing device and a host. The wireless pointing device comprises an inertial sensor module and a first wireless transceiver module. The inertial sensor module is adapted to detect a movement of the wireless pointing device so as to output a displacement data. The first wireless transceiver module is adapted to output the displacement data to the host via a wireless transmission mode. The host comprises a third wireless transceiver module, an image processing module, and a monitor. The monitor is adapted to display a cursor. The image processing module is adapted to process a position data of the cursor and a resolution data of the monitor. The third wireless transceiver module is adapted to receive the displacement data from the wireless pointing device via the wireless transmission mode for calculating an offset value pertaining to the position data of the cursor and subsequently transmitting the offset value to the monitor so as to allow the image processing module to control cursor movement of the monitor.

Hence, it is a primary objective of the present invention to provide an electronic apparatus with offset correction for controlling cursor movement. The offset correcting calculation module provided in the electronic apparatus is adapted to receive the displacement data from the inertial sensor and the resolution data from the image processing module to calculate the offset value of the monitor and subsequently to control the movement of the cursor for further controlling cursor movement on the monitor. Therefore, the user can control the position of the cursor on the monitor by the wireless point device in a user-friendly way.

It is a secondary objective of the present invention to provide an electronic apparatus with offset correction for controlling cursor movement. The electronic apparatus further comprises a cursor reset means to provide users with an option to reposition the cursor at a center of the monitor. Therefore, the user can control the position of the cursor on the monitor by the wireless point device in a user-friendly way.

It is third objective of the present invention to provide an electronic apparatus with offset correction for controlling cursor movement. The electronic apparatus further comprises a resolution reset means to provide users with an option to set a desired value of the monitor's resolution. Therefore, the user can adjust the resolution of the monitor anytime so as to greatly improve the position offset between the cursor on the monitor and the wireless point device.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram showing an electronic apparatus with offset correction for controlling cursor movement according to a first preferred embodiment of the present invention.

FIG. 2 is a block diagram showing an electronic apparatus with offset correction for controlling cursor movement according to a second preferred embodiment of the present invention.

FIG. 3 is a block diagram showing an electronic apparatus with offset correction for controlling cursor movement according to a third preferred embodiment of the present invention.

FIG. 4 is a block diagram showing an electronic apparatus with offset correction for controlling cursor movement according to a fourth preferred embodiment of the present invention.

### DETAILED DESCRIPTION OF THE INVENTION

An electronic apparatus with offset correction for controlling cursor movement thereof has been disclosed in the invention; where the principles of signal transmission between a pointing device and a host may be easily comprehended by those of ordinary skill in relevant technical fields, and thus will not be further described hereafter. Meanwhile, it should be noted that the drawings referred to in the following paragraphs only serve the purpose of illustrating structures related to the characteristics of the disclosure, and are not necessarily drawn according to actual scales and sizes of the disclosed objects. Some particular embodiments of the invention will be described in detail for purpose of illustration, and one of ordinary skill in the art can easily understand the advantages and efficacy of the present invention through the disclosure of the specification. It is to be understood that alternative embodiments may be possible for the implement and application of the present invention while numerous variations will be possible to the details disclosed in the specification on the strength of diverse concepts and applications without going outside the scope of the invention as disclosed in the claims.

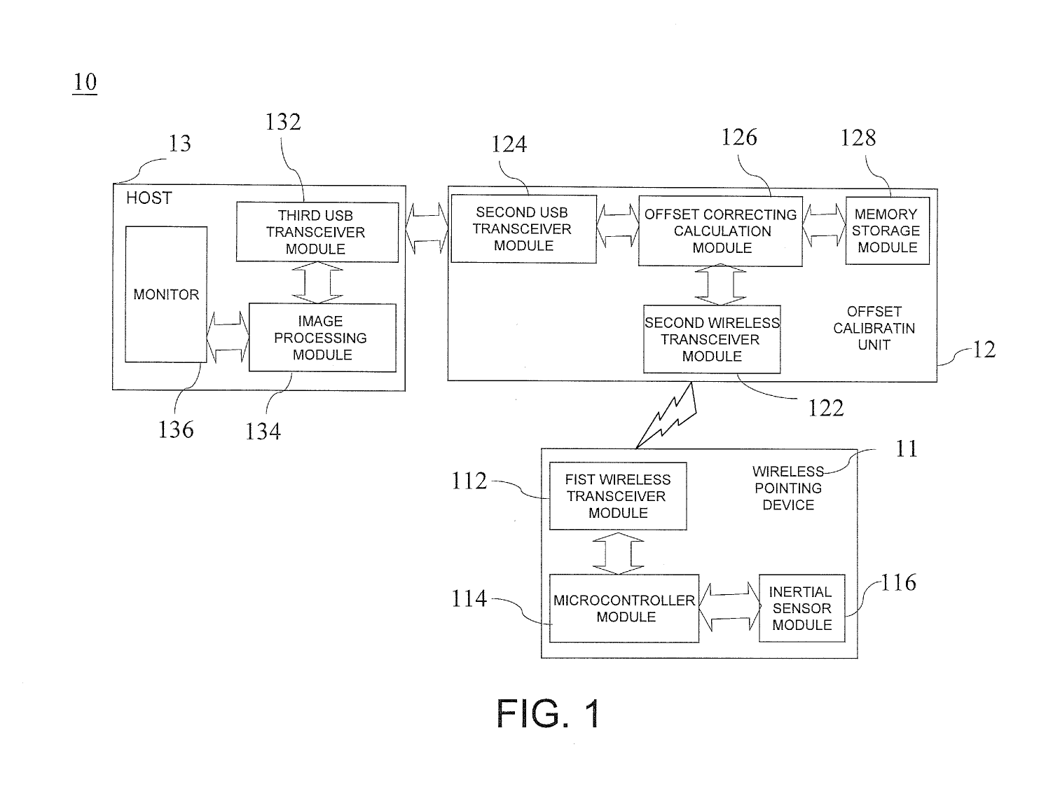

Referring to FIG. 1, an electronic apparatus 10 with offset correction for controlling cursor movement is disclosed in a first preferred embodiment according to the present invention. The electronic apparatus 10 comprises a wireless pointing device 11, a host 13 and an offset calibration unit 12. The wireless pointing device 11 comprises a first wireless transceiver module 112, a microcontroller module 114, and an inertial sensor module 116 which is adapted to detect a movement of the wireless pointing device 11 so as to output moving displacement corresponding to the movement of the wireless pointing device 11. The microcontroller module 114 is adapted to output a displacement data corresponding to the moving displacement. The first wireless transceiver module 112 is adapted to receive the displacement data from the microcontroller module 114, and transmits the displacement data via a wireless transmission mode. The host 13 comprises a third USB transceiver module 132, an image processing module 134, and a monitor 136. The monitor 136 is adapted to display a cursor for users. The image processing 134 is adapted to process a position data of the cursor and a resolution data of the monitor. The third USB transceiver module 132 is adapted to operate data communication with the offset calibration unit 12. The offset calibration unit 12 comprises a second wireless transceiver module 122, a second USB transceiver module 124, an offset correcting calculation module 126 and a memory storage module 128. The offset calibration unit 12 is adapted to calculate the displacement data of the cursor. The second wireless transceiver module 122 is adapted to receive the displacement data from the first wireless transceiver module 112 via the wireless transmission mode. The second USB transceiver module 124 is adapted to receive the resolution data from the monitor 136 through the third USB transceiver module 132 in the host 13 via a USB transmission protocol. The offset correcting calculation module 126 is adapted to receive the displacement data from the wireless pointing device 11 through the second wireless transceiver module 122 and the resolution data from the monitor 136 through the second USB transceiver module 124, so as to calculate an offset value pertaining to the position data of the cursor based on the displacement data and the resolution data in order to control the movement of the cursor on the monitor 136. Therefore, the user can friendly control the position of the cursor by means of the wireless pointing device 11. In addition, the memory storage module 128 is adapted to store all the required data pertaining to calculation of the offset value generated from the offset correcting calculation module 126. The memory storage module 128 at least stores the displacement data pertaining to the wireless pointing device 11, the resolution data pertaining to the monitor 136, and the offset value pertaining to the cursor.

In the first preferred embodiment, the displacement data is further defined by both an x-axis displacement value Xd and a y-axis displacement value Yd to represent a movement value of the wireless pointing device 11 with reference to the current cursor position on the monitor 136. The resolution data of the monitor 136 is further defined by an x-axis boundary position Xb and a y-axis boundary position Yb. The offset value is further defined by an x-axis boundary offset value x and a y-axis boundary offset value y. Besides, the wireless transmission modes can be one of radio frequency (RF), wireless fidelity (Wi-Fi), Bluetooth, Worldwide Interoperability for Microwave Access (WiMax) and Ultra wideband (UWB). The first wireless transceiver modules 112 and the second wireless transceiver modules 122 are operative to meet 2.4 GHz low power wireless transceiver modules. The inertial sensor module 116 can be one of gyroscope, accelerometer and magnetic sensor. The memory storage module 128 can be FLASH, EEPROM, or ROM memory storage module. In addition, the electronic apparatus 10 further comprises a cursor reset means (not shown) to provide users with an option to reposition the cursor at a center of the monitor 136 so as that the user can control the position of the cursor on the monitor by the wireless point device in a user-friendly way. The electronic apparatus 10 further comprises a resolution reset means (not shown) to provide users with an option to set a desired value of the monitor's resolution. The offset value can be calculated according to the resolution data. Besides, the offset calibration unit 12 can be configured as a dongle card between the wireless pointing device 11 and the host 13.

In the first preferred embodiment, the method of calibrating the position offset of the cursor comprises the steps of:

Step 1: providing boundary positions in a coordinate system and resetting a pair of boundary offset values where the boundary positions in the coordinate system are defined by resolution (including horizontal pixels and vertical pixels) of the screen. The boundary positions are, namely an x-axis boundary position Xb and a y-axis boundary position Yb of the screen. Xb defines a boundary range of the x-axis of the screen, including a leftmost x-axis boundary value Xbl (minimum value) and a rightmost x-axis boundary value Xbr (maximum value). Yb defines a boundary range of the y-axis of the screen, including an uppermost y-axis boundary value Ybu (maximum value) and a lowermost y-axis boundary value Ybl (minimum value). The pair of boundary offset values are, namely an x-axis boundary offset value x and a y-axis boundary offset value y. x refers to the excess value of displacement of the cursor from the x-axis boundary position of the screen. y refers to the excess value of displacement of the cursor from the y-axis boundary position of the screen. The step can further involve performing a position initialization of the cursor so as to reposition the cursor on the screen. In the first preferred embodiment of the present invention, the cursor can be initialized at the center of the screen.

Step 2: confirming whether or not the resolution of the screen has altered by the user so as to update the x-axis boundary position Xb and the y-axis boundary position Yb in the coordinate system of the screen. The step can further involve calculation of the boundary values. When the resolution of the screen is altered by the user, the boundary values for the current boundary positions x-axis Xb and y-axis Yb in the coordinate system are being redefined to a new x-axis boundary position and a new y-axis boundary position, and then position initialization of the cursor is performed later on. In so doing, upon alteration of the resolution of the screen, the cursor position is initialized and repositioned at the center of the screen.

Step 3: determining a pair of displacement values representative of an x-axis displacement value Xd and a y-axis displacement value Yd of the cursor upon receipt of an inertial sensing signal generated from an inertial sensor of the pointing device. It is noted that the displacement values (Xd, Yd) are generated in response to the pointing device moved by the user. According to the present invention, the inertial sensor generates a negative displacement value Xd when the pointing device is being moved leftward along the x-axis, a positive displacement value Xd when being moved rightward along the x-axis, a negative displacement value Yd when being moved downward along the y-axis, and a positive displacement value Yd when being moved upward along the y-axis. The inertial sensor can be a gyroscope, an accelerometer, or a magnetic sensor.

Step 4: calculating a new pair of virtual coordinates (x′, y′) of the cursor according to the x-axis displacement value Xd and the y-axis displacement value Yd, where x′=current x-axis virtual position x of the cursor+Xd; and y′=current y-axis virtual position y of the cursor+Yd;

Step 5: calculating a new pair of boundary offset values (x, y) of the cursor based on the new pair of virtual coordinates (x′, y′) of the cursor so as to determine whether or not (x′, y′) fall within the boundaries (Xb, Yb) of the coordinate system on the screen. The determination for (x, y) is evaluated against the following criteria:

(5.1) the x-axis boundary offset value x is set to zero if the new virtual coordinates x′ of the cursor fall within the x-axis boundary positions Xb (Xbl, Xbr) after the cursor is moved by the x-axis displacement value Xd

(5.2) the x-axis boundary offset value x is calculate and recorded if the cursor falls outside the x-axis boundary positions Xb (Xbl, Xbr) in the coordinate system after the cursor is moved by the x-axis displacement value Xd, where x=x′−Xb;

(5.3) the y-axis boundary offset value y is reset (e.g. y is set to zero) if the new virtual coordinates y′ of the cursor fall within the y-axis boundary positions Yb (Ybl, Ybu) after the cursor is moved by the y-axis displacement value Yd;

(5.4) the y-axis boundary offset value y is calculated and recorded if the cursor falls outside the boundary positions Yb (Ybl, Ybu) in the coordinate system after the cursor is moved by the x-axis displacement value Xd, where y=y′−Yb.

Step 6: outputting the cursor's movement on the screen according to the following criteria:

(6.1) given x=y=0, converting the new pair of virtual coordinates (x′, y′) of the cursor into real coordinates (x, y), where x is set to x′, and y is set to y′, and thus the cursor is moved to a new position of the screen corresponding to the real coordinates (x, y);

(6.2) given x≠0 and y=0, converting the new pair of virtual coordinates (x′, y′) of the cursor into real coordinates (x, y), where x is set to Xb, y is set to y′, and thus the cursor is moved to a new position of the screen corresponding to the real coordinates (x, y);

(6.3) given x=0 and y≠0, converting the new pair of virtual coordinates (x′, y′) of the cursor into real coordinates (x, y), where x is set to x′, y is set to Yb, and thus the cursor is moved to a new position of the screen corresponding to the real coordinates (x, y); and

(6.4) given x≠0 and y≠0, converting the new pair of virtual coordinates (x′, y′) of the cursor into real coordinates (x, y), where x is set to Xbr, and y is set to Ybl, and thus the cursor is moved to a new position of the screen corresponding to the real coordinates (x, y).

Step 7: examining the screen's resolution, so as to allow alteration of the resolution of the screen when the pair of x and y equal zero.

Step 8: ending the method, or returning to the Step 2.

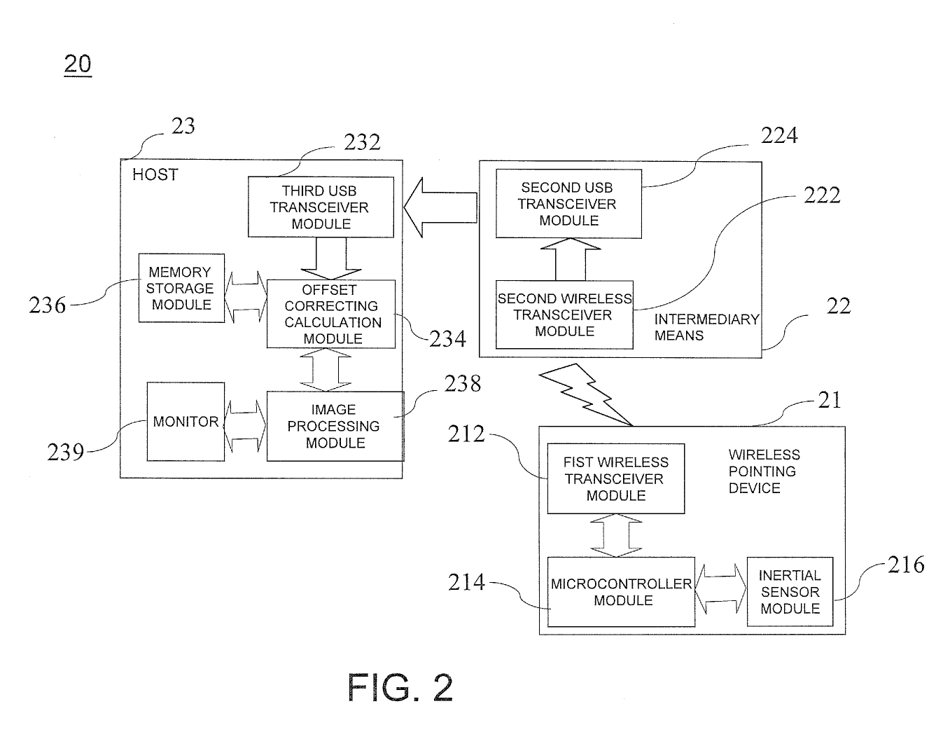

Referring to FIG. 2, an electronic apparatus 20 with offset correction for controlling cursor movement is disclosed in a second preferred embodiment according to the present invention. The electronic apparatus 20 comprises a wireless pointing device 21, an intermediary means 22 and a host 23. The wireless pointing device 21 comprises a first wireless transceiver module 212, a microcontroller module 214 and an inertial sensor module 216. The inertial sensor module 216 is adapted to detect a movement of the wireless pointing device 21 so as to output a moving displacement corresponding to the movement of the wireless pointing device 21. The microcontroller module 214 is adapted to output a displacement data corresponding to the moving displacement. The first wireless transceiver module 212 is adapted to transmit the displacement data via a wireless transmission mode. The intermediary means 22 is configured between the wireless pointing device 21 and the host 23, and has a second wireless transceiver module 222 and a second USB transceiver module 224. The second wireless transceiver module 222 is adapted to receive the displacement data from the wireless pointing device 21 via the wireless transmission mode. The second USB transceiver module 224 is adapted to receive and to transmit the displacement data. The host 23 comprises a third USB transceiver module 232, an image processing module 238 and a monitor 239. The monitor 239 is adapted to display a cursor. The image processing module 238 is adapted to process a position data of the cursor and a resolution data of the monitor 239. The third USB transceiver module 232 is adapted to receive the displacement data from the second USB transceiver module 224 in the intermediary means 22. The host 23 further comprises an offset correcting calculation module 234 and a memory storage module 236. The offset correcting calculation module 234 is adapted to receive the displacement data from the third USB transceiver module 232 and the resolution data from the image processing module 238, so as to calculate an offset value pertaining to the position data of the cursor for further controlling cursor movement on the monitor 239. The memory storage module 236 is adapted to store all the required data pertaining to calculation of the offset value in the offset correcting calculation module 234. The memory storage module 236 at least stores the displacement data pertaining to the wireless pointing device, the resolution data pertaining to the monitor, and the offset value pertaining to the cursor. In addition, the parameters and the method of calibrating a position offset of the cursor in the second preferred embodiment is equivalent to those of the first preferred embodiment.

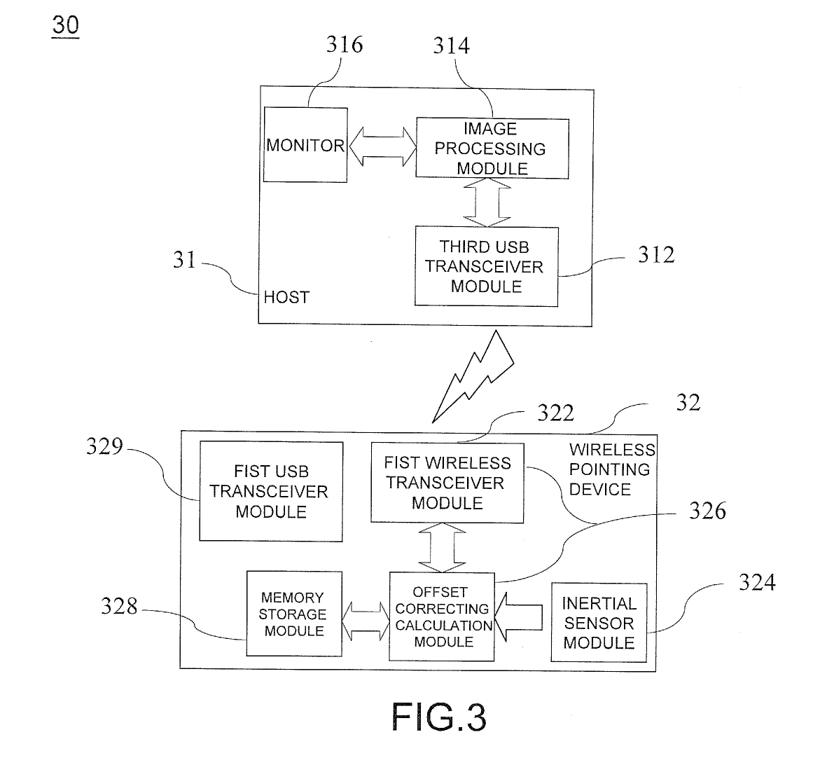

Referring to FIG. 3, an electronic apparatus 30 with offset correction for controlling cursor movement is disclosed in a third preferred embodiment according to the present invention. The electronic apparatus 30 with offset correction for controlling cursor movement. The electronic apparatus 30 comprises a host 31 and a wireless pointing device 32. The host 31 comprises a third wireless transceiver module 312, an image processing module 314 and a monitor 316. The monitor 316 is adapted to display a cursor. The image processing module 314 is adapted to process a position data of the cursor and resolution data of the monitor 316. The third wireless transceiver module 312 is adapted to operate data communication with the wireless pointing device 32 via a wireless transmission mode. The wireless pointing device 32 comprises an inertial sensor module 324 and a first wireless transceiver module 322. The inertial sensor module 324 is adapted to detect a movement of the wireless pointing device 32 so as to output a displacement data. The first wireless transceiver module 322 is adapted to operate data communication with the host 31 via the wireless transmission mode. The wireless pointing device 32 further comprises an offset correcting calculation module 326 and a memory storage module 328. The offset correcting calculation module 326 is adapted to receive the resolution data from the host 31 through the first wireless transceiver module 322 and the displacement data from the inertial sensor module 324 for calculating an offset value pertaining to the position data of the cursor and subsequently transmitting the offset value to the host 31 through the first wireless transceiver module 322 and the third wireless transceiver module 312, so as to allow the image processing module 314 to control cursor movement om the monitor 316. The memory storage module 328 is adapted to store all the required data pertaining to calculation of the offset value generated form the offset correcting calculation module 326. The memory storage module 326 at least stores the displacement data pertaining to the wireless pointing device, the resolution data pertaining to the monitor, and the offset value pertaining to the cursor. In addition, the parameters and the method of calibrating a position offset of the cursor in the second preferred embodiment is equivalent to those of the first preferred embodiment. Also, the electronic apparatus 30 can further comprise a first USB transceiver module 329 such that data transmission is performed from the wireless pointing device 32 to peripheral devices via a USB interface.

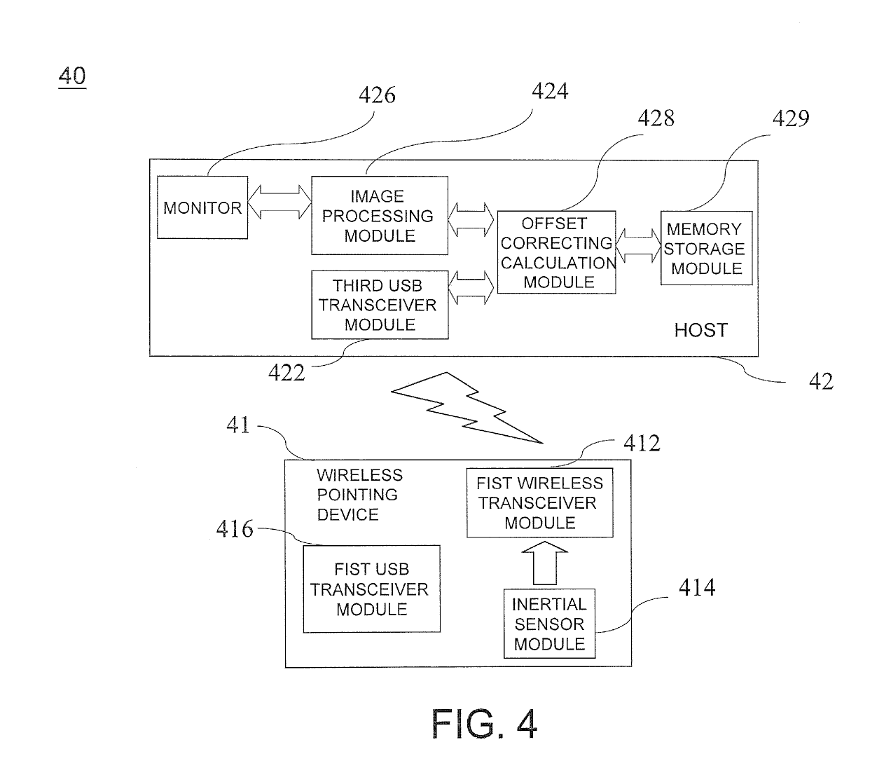

Referring to FIG. 4, an electronic apparatus 40 with offset correction for controlling cursor movement is disclosed in a forth preferred embodiment according to the present invention. The electronic apparatus 40 with offset correction for controlling cursor movement comprises a wireless pointing device 41 and a host 42. The wireless pointing device 41 comprises an inertial sensor module 414 and a first wireless transceiver module 412. The inertial sensor module 414 is adapted to detect a movement of the wireless pointing device 41 so as to output a displacement data. The first wireless transceiver module 412 is adapted to output the displacement data to the host 42 via a wireless transmission mode. The host 42 comprises a third wireless transceiver module 422, an image processing module 424 and a monitor 426. The monitor 426 is adapted to display a cursor. The image processing module 424 is adapted to process a position data of the cursor and a resolution data of the monitor. The third wireless transceiver module 422 is adapted to receive the displacement data from the wireless pointing device 41 via the wireless transmission mode. The host 42 further comprises an offset correcting calculation module 428 and a memory storage module 429. The offset correcting calculation module 428 is adapted to receive the resolution data from the image processing module 424 and the displacement data from the third wireless transceiver module 422 so as to calculate an offset value pertaining to the position data of the cursor on the monitor 426. The memory storage module 429 is adapted to store all the required data pertaining to calculation of the offset generated from the offset correcting calculation module 428. The memory storage module 429 at least stores the displacement data pertaining to the offset correcting calculation module 428, the resolution data pertaining to the monitor, and the offset value pertaining to the cursor. In addition, the parameters and the method of calibrating a position offset of the cursor in the second preferred embodiment is equivalent to those of the first preferred embodiment. Also, the electronic apparatus 40 can further comprise a first USB transceiver module 416 such that data transmission is performed from the wireless pointing device 41 to peripheral devices via a USB interface.

Although some particular embodiments of the invention have been described in detail for purposes of illustration, it will be understood by one of ordinary skill in the art that numerous variations will be possible to the disclosed embodiments without departing from the scope of the invention as disclosed in the claims.

What is claimed is:

1. An electronic apparatus with offset correction for controlling cursor movement, comprising:
a wireless pointing device having a first wireless transceiver module, a microcontroller module and an inertial sensor module, said inertial sensor module being adapted to detect a movement of said wireless pointing device so as to output a moving displacement corresponding to said movement of said wireless pointing device, said microcontroller module being adapted to output displacement data corresponding to said moving displacement, said first wireless transceiver module being adapted to transmit said displacement data via a wireless transmission mode;
an offset calibration unit receiving said displacement data from said wireless pointing device for further calculation; and
a host having a monitor, an image processing module and a third USB transceiver module, said monitor being adapted to display a cursor, said image processing module being adapted to process a
position data of said cursor and a resolution data of said monitor, said third USB transceiver module being adapted to operate data communication between said host and said offset calibration unit;
wherein said offset calibration unit further comprises a second wireless transceiver module, a second USB transceiver module, an offset correcting calculation module and a memory storage module, said second wireless transceiver module being adapted to operate data communication with said wireless pointing device via said wireless transmission mode, said second USB transceiver module being adapted to operate data communication with said host, said offset correcting calculation module being adapted to receive said displacement data from said wireless pointing device through said second wireless transceiver module and said resolution data from said monitor through said second USB transceiver module so as to calculate an offset value pertaining to said position data of said cursor based on said displacement data and said resolution data, said memory storage module being adapted to store all the required data pertaining to calculation of said offset value generated from said offset correcting calculation module.

2. The electronic apparatus with offset correction for controlling cursor movement as claimed in claim 1, wherein said memory storage module at least stores said displacement data pertaining to said wireless pointing device, said resolution data pertaining to said monitor, and said offset value pertaining to said cursor.

3. The electronic apparatus with offset correction for controlling cursor movement as claimed in claim 2, wherein said displacement data is further defined by both a x-axis displacement value and a y-axis displacement value to represent a movement value of said wireless pointing device with reference to said monitor.

4. The electronic apparatus with offset correction for controlling cursor movement as claimed in claim 2, wherein said resolution data is further defined by a x-axis boundary position and a y-axis boundary position.

5. The electronic apparatus with offset correction for controlling cursor movement as claimed in claim 2, wherein said offset value is further defined by a x-axis boundary offset value and a y-axis boundary offset value.

6. The electronic apparatus with offset correction for controlling cursor movement as claimed in claim 1, wherein said wireless transmission modes is selected from the group consisting of radio frequency (RF), wireless fidelity (Wi-Fi), Bluetooth, Worldwide Interoperability for Microwave Access (WiMax), and Ultra wideband (UWB).

7. The electronic apparatus with offset correction for controlling cursor movement as claimed in claim 1, wherein said wireless transceiver modules is provided to meet 2.4 GHz low power wireless transceiver modules.

8. The electronic apparatus with offset correction for controlling cursor movement as claimed in claim 1, wherein said inertial sensor module is selected from the group consisting of a gyroscope, an accelerometer and magnetic sensor.

9. The electronic apparatus with offset correction for controlling cursor movement as claimed in claim 1, wherein said wireless pointing device further comprises a cursor reset means to provide users with an option to reposition said cursor at a center of said monitor.

10. The electronic apparatus with offset correction for controlling cursor movement as claimed in claim 1, wherein said wireless pointing device further comprises a resolution reset means to provide users with an option to set a desired value of said monitor's resolution.

11. An electronic apparatus with offset correction for controlling cursor movement, comprising a host and a wireless pointing device,
wherein said host has a monitor, an image processing module and a third wireless transceiver module, said monitor being adapted to display a cursor, said image processing module being adapted to process a position data of said cursor and a resolution data of said monitor, said third wireless transceiver module being adapted to operate data communication with said wireless pointing device via a wireless transmission mode;
wherein said wireless pointing device comprises an inertial sensor module and a first wireless transceiver module, said inertial sensor module being adapted to detect a movement of said wireless pointing device so as to output a displacement data, said first wireless transceiver module being adapted to operate data communication with said host via said wireless transmission mode; and
wherein said wireless pointing device further comprises an offset correcting calculation module and a memory storage module, said offset correcting calculation module being adapted to receive said resolution data from said host through said first wireless transceiver module and said displacement data from said inertial sensor module for calculating an offset value pertaining to said position data of said cursor and subsequently transmitting said offset value to said host through said first wireless transceiver module so as to allow said image processing module to control cursor movement of said monitor, said memory storage module being adapted to store all the required data pertaining to calculation of said offset value generated form said offset correcting calculation module.

12. An electronic apparatus with offset correction for controlling cursor movement, comprising a wireless pointing device and a host,
wherein said wireless pointing device comprises an inertial sensor module and a first wireless transceiver module, said inertial sensor module being adapted to detect a movement of said wireless pointing device so as to output a displacement data, said first wireless transceiver module being adapted to output said displacement data to said host via a wireless transmission mode; and
wherein said host comprises a monitor, an image processing module, a third wireless transceiver module, an offset correcting calculation module and a memory storage module, said monitor being adapted to display a cursor, said image processing module being adapted to process a position data of said cursor and a resolution data of said monitor, said third wireless transceiver module being adapted to receive said displacement data from said wireless pointing device via said wireless transmission mode, said offset correcting calculation module being adapted to receive said resolution data from said image processing module and said displacement data from said third wireless transceiver module so as to calculate an offset value pertaining to said position data of said cursor on said monitor, said memory storage module being adapted to store all the required data pertaining to calculation of said offset generated from said offset correcting calculation module.
